(19) United States
(12) Patent Application Publication
(10) Pub. No.: US 2012/0293052 A1
(43) Pub. Date: Nov. 22, 2012

(54) WORK TOP AND HOUSEHOLD APPLIANCE HAVING A LAUNDRY HANGING DEVICE

(75) Inventor: Gerhard Stegerwald, New Bern, NC (US)

(73) Assignee: BSH HOME APPLIANCES CORPORATION, Huntington Beach, CA (US)

(21) Appl. No.: 13/108,173

(22) Filed: May 16, 2011

(51) Int. Cl. D06F 39/14; A47B 37/00; F16B 12/00; A47B 81/00

(52) U.S. Cl. 312/111; 312/326; 312/228; 108/50.11

(57) ABSTRACT

A domestic household laundry appliance including a housing having a door for accessing an interior of the housing, and an attachment device on the housing, the attachment device for securing and supporting a laundry hanger device. The laundry hanger device is releasably secured in the attachment device.

### FIELD OF THE INVENTION

The present invention is directed to a household appliance or a work top for a household appliance having laundry hanging functionality, and more particularly, to a household appliance or a work top including an attachment device for a deployable or adjustable laundry hanger device.

### BACKGROUND OF THE INVENTION

A domestic household appliance, such as a laundry washer or dryer, generally includes a housing having a door that covers an opening for accessing the interior of the appliance. The household appliance commonly includes a washing unit or drying unit in the interior of the appliance housing. The washing unit of a washer includes a tub having a cylindrical washing drum rotatably mounted inside the tub and a driver device for driving the rotating drum. The drying unit of a dryer similarly includes a rotatable cylindrical drum and a driver device for driving the rotating drum.

Front-load clothes washers and dryers, which have a door positioned on the front of the appliance, have become increasingly popular in recent years for household use. Such front-load washers and dryers commonly include glass or see-through portions in the door to allow an operator to monitor the laundry while it is in the rotating drum. In operation, the door of the appliance is opened and clothes or laundry are inserted into the household appliance through the opening and placed in the rotating drum and the door is then closed. In the case of a washer, the household appliance wets the laundry to be washed with washing liquid and mechanically moves the laundry to release contaminants from the laundry, for example, during a low speed tumbling cycle in which the drive system rotates the drum at a low speed. In the case of a dryer, the household appliance tumbles and mechanically moves the laundry within the drum, for example, while heating the air within the drum and/or extracting moisture from the air within the drum to dry the laundry.

After the wash cycle of the washer is complete, a user commonly removes the washed laundry from the washer and, depending on the particular care instructions for each piece of laundry, either places the pieces of laundry or clothing into the dryer for drying, or hangs or places the pieces of laundry or clothing on another object to air dry. For the laundry to air dry, the laundry commonly must be hung, draped, or spread out on a surface or structure, which may require a large amount of available area, depending on the quantity of laundry that requires air drying. If the user washes and dries multiple loads of laundry in a short time period, the amount of available space needed for air drying laundry can be further increased. As a result, the user commonly may hang laundry in various locations throughout the house, such as on door frames, door knobs, wall fixtures or hooks, furniture, portable drying racks, or any other available hanging areas.

Some conventional laundry appliances, such as front-load washers and dryers, may include a separate or integral work surface on the top of the appliance that may be used to spread out laundry for drying or folding. Some other conventional laundry appliances may include a translatably-deployable drawer or work surface on the top of the appliance or stacked between (i.e., sandwiched between) laundry machines in a vertically stacked configuration, such as a stacked washer and dryer. The conventional translatably-deployable drawer or work surface may include a pull-out drawer or drying rack (i.e., translatable drawer). The conventional pull-out drawer or work surface commonly uses conventional side rails and mounting hardware to enable the drawer or work surface to be translatably deployable from a housing.

Some other conventional laundry appliances may include a fold-out work surface or drying rack that folds or pivots out from a surface of the appliance. Other conventional laundry appliances may include permanently mounted frames or hanger rods mounted to the work surface or the laundry appliance.

### SUMMARY OF THE INVENTION

The exemplary embodiments of the present invention recognize that the conventional pull-out drawer or work surfaces, fold out drying racks, and permanently mounted frames or hanger rods may be cumbersome and may interfere with an available area for a user to access the household appliance or limit the area around the household appliance, particularly when the devices are not in use. Additionally, the conventional devices may provide limited flexibility to the user and also distract from the aesthetic appearance of the laundry appliance. Furthermore, the conventional devices may require multiple parts, such as side rails, hinges, and complex mounting hardware, that may result in an increase in material and labor costs. The complex conventional devices also may be difficult for a user to use and may provide limited adjustability for the user.

These problems and others are addressed by the present invention, a first exemplary embodiment of which comprises a domestic household laundry appliance comprising a housing having a door for accessing an interior of the housing, and an attachment device on the housing, the attachment device for securing and supporting a laundry hanger device.

Another exemplary embodiment of the invention includes a domestic household laundry appliance comprising a housing having a door for accessing an interior of the housing, and attachment means on the housing and/or a worktop on the housing, the attachment means for securing and supporting laundry hanger means.

Another exemplary embodiment of the invention includes a worktop for a domestic household laundry appliance, the worktop comprising a housing, and attachment means on the housing, the attachment means for securing and supporting laundry hanger means.

Yet another exemplary embodiment of the invention includes a domestic household laundry system comprising a first household laundry appliance including a first housing having a door for accessing an interior of the first housing, a second household laundry appliance including a second housing having a door for accessing an interior of the second housing, a first attachment device on the first housing and/or a first worktop on the first housing, and a first laundry hanger device secured and supported by the first attachment device.

The domestic household laundry system also can include a second attachment device on the second housing and/or a second worktop. In one embodiment, a second laundry hanger device can be secured and supported by the second attachment device. In another embodiment, a first end of the first laundry hanger device can be secured and supported by the first attachment device and a second end of the first laundry hanger device can be secured and supported by the second attachment device.

The first household laundry appliance can be configured in a side-by-side arrangement with the second household laundry appliance. In this case, the first and second attachment devices each can be on a side panel of the first and second housings, respectively, or alternatively, on the side panels of the first and second worktops, respectively. In another embodiment, the first and second attachment devices each can be on a front panel of the first and second housings, respectively, or alternatively, on the front panels of the first and second worktops, respectively. In yet another embodiment, the first and second attachment devices each can be on a top panel of the first and second housings, respectively, or alternatively, on the top panels of the first and second worktops, respectively. In still another embodiment, the first and second attachment devices can include a cutout formed in an edge of the first and second housings, respectively, or alternatively, a cutout formed in an edge of the first and second worktops, respectively.

In this manner, the exemplary embodiments provide integrated or removable laundry hanging devices, and particularly, deployable or adjustable laundry hanger rods, that are less cumbersome, reduce or eliminate interference with an available area for a user to access the household appliance, and increase or maximize the usable area around the household appliance, even in cases when the laundry hanging devices are not in use. Additionally, the exemplary embodiments provide selectability and flexibility to the user and may remain hidden when not in use to maintain the aesthetic appearance of the laundry appliance. Furthermore, the exemplary embodiments provide simple and efficient laundry hanging functions that are easy to use, adjust, and manipulate. Additionally, the simple and efficient laundry hanging devices may reduce material and labor costs compared to conventional complex and cumbersome laundry hanging devices.

The exemplary domestic household laundry system having a first household laundry appliance configured in a side-by-side arrangement with a second household laundry appliance enables a second laundry hanger device to be secured and supported by or between the first and second laundry appliances, thereby distributing the load or forces on the laundry hander device and the appliances.

For purposes of this disclosure, an attachment device is defined as a structure forming a port or socket for receiving deployable or adjustable laundry hanger rods and/or rack systems. The attachment device can be integrally formed in the housing of the laundry appliance or in a surface of a worktop of the laundry appliance. In other embodiments, the attachment device can include, for example, a base having a port or socket for receiving deployable or adjustable laundry hanger rods and rack systems. The base can be coupled to the housing of the laundry appliance or a surface of a worktop of the laundry appliance. In another embodiment, the attachment device can include a flap or cover (e.g., a pivotable or translatable flap or cover) that covers the opening of the attachment device to hide the attachment device, or to provide an appearance of a clean and uninterrupted surface of the housing of the laundry appliance, or a surface of the worktop of the laundry appliance, during a state of non-use.

The exemplary embodiments provide attachment devices and laundry hanging devices that can be integrally formed with the laundry appliance, such as a washer or dryer, or with a work top for such a laundry appliance. The laundry hanging devices can include means for hanging laundry or clothing, such as extendible or telescopic laundry hanging bars, rods, and laundry rack systems.

The laundry hanging devices may be selectively and adjustably inserted into one or more attachment devices integrally formed with or on the appliance housing or worktop. In other embodiments, the laundry hanging devices may be selectively and adjustably extendible and/or collapsible into the attachment devices on the housing of the laundry appliance or worktop, or onto a surface of the housing of the laundry appliance or worktop. The attachment devices may be integrally formed with the appliance housing or worktop housing to be hidden or concealed when not in use, or to be flush with the surface of the housing of the laundry appliance or worktop when not in use, or otherwise unobtrusive to the user. The laundry hanging devices may be selectively and adjustably movable from a stored position to a deployed position.

A plurality of attachment devices for the insertable, telescopic, extendible, or collapsible laundry hanging devices can be provided at a variety of locations on the appliance housing or worktop. The exemplary embodiments can provide customizable orientations and expandable drying areas, thereby providing greater flexibility to the user and the ability to selectively accommodate the user's particular drying needs or preferences for hanging or drying laundry, for example, depending on the amount of laundry or types of laundry to be hung or dried in the household. The insertable, telescopic, extendible, or collapsible laundry hanging devices can be movable or pivotable to provide further flexibility to the user. The laundry hanging devices can be configurable to selectively increase or reduce the number of laundry hanging bars, rods, and/or laundry rack systems, thereby providing further flexibility to the user.

In an embodiment, a plurality of laundry hanging devices can be deployable to selectively extend out of, and collapse into, the housing of the laundry appliance or worktop. In another embodiment, the housing of the laundry appliance or worktop can include one or more attachment devices, ports, and/or bases configured to receive one or more types of laundry hanging devices. The attachment devices can include pivotable or translatable attachment devices. The exemplary laundry hanging devices can include devices having a plurality of types, sizes, and orientations that are connectible with each other and manipulatable to provide increased selectability and flexibility to the user.

The exemplary embodiments can include extension components, such as telescopic extensions, that can be added to other laundry hanging devices to achieve a greater length of extension.

In this manner, the exemplary embodiments can provide a plurality of laundry hanging devices for a laundry appliance, such as a washer or dryer, that enable the user to easily and efficiently hang laundry, for example, to be dried directly on the laundry appliances when the laundry is removed from the washer after completion of a wash cycle, thereby avoiding or reducing the user's need to hang laundry in various locations throughout the house.

Other features and advantages of the present invention will become apparent to those skilled in the art upon review of the following detailed description and drawings.

### BRIEF DESCRIPTION OF THE DRAWINGS

These and other aspects and features of embodiments of the present invention will be better understood after a reading of the following detailed description, together with the attached drawings, wherein:

FIG. 1 is a front elevation view of a washer.

FIG. 2 is a front elevation view of a dryer.

FIG. 3 is a front perspective view of a household appliance according to an exemplary embodiment of the invention.

FIG. 4 is a front perspective view of a pair of stacked household appliances according to an exemplary embodiment of the invention.

FIG. 5 is a front perspective view of a pair of stacked household appliances according to another exemplary embodiment of the invention.

FIG. 6 is a front perspective view of a household appliance according to an exemplary embodiment of the invention.

FIG. 7 is a front perspective view of a household appliance according to an exemplary embodiment of the invention.

FIG. 8 is a front perspective view of a household appliance according to an exemplary embodiment of the invention.

FIG. 9 is a front perspective view of a household appliance according to an exemplary embodiment of the invention.

FIG. 10 is a front perspective view of a household appliance according to an exemplary embodiment of the invention.

FIG. 11A is a perspective view of a laundry hanger rod according to an exemplary embodiment of the invention.

FIG. 11B is a perspective view of a laundry hanger rod according to an exemplary embodiment of the invention.

FIG. 11C is a perspective view of a laundry hanger rod according to an exemplary embodiment of the invention.

FIG. 11D is a perspective view of a laundry hanger rod according to an exemplary embodiment of the invention.

FIG. 12 is a front perspective view of a pair of side-by-side household appliances according to an exemplary embodiment of the invention.

FIG. 13 is a front perspective view of a pair of side-by-side household appliances according to another exemplary embodiment of the invention.

FIG. 14 is a front perspective view of a pair of worktops for a pair of side-by-side household appliances according to an exemplary embodiment of the invention.

FIG. 15 is a front perspective view of a pair of worktops for a pair of side-by-side household appliances according to another exemplary embodiment of the invention.

FIG. 16 is a front perspective view of a pair of side-by-side household appliances according to an exemplary embodiment of the invention.

FIG. 17A is a perspective view of a laundry hanger rod according to an exemplary embodiment of the invention.

FIG. 17B is a perspective view of a laundry hanger rod according to another exemplary embodiment of the invention.

### DETAILED DESCRIPTION OF THE EXEMPLARY EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

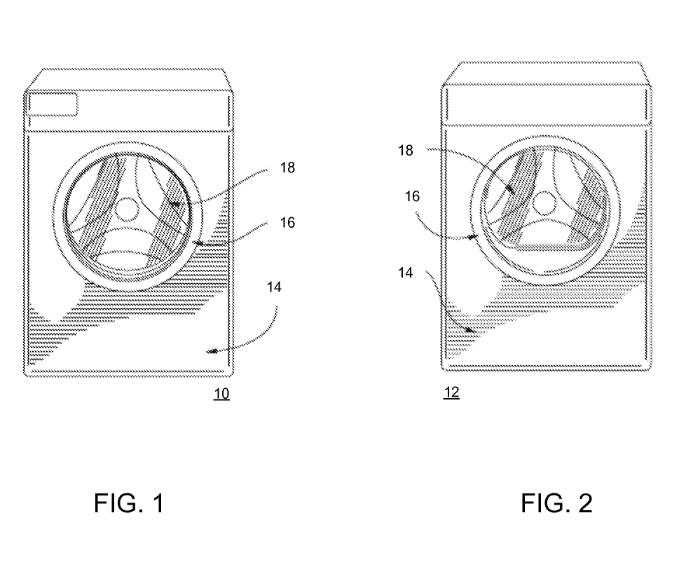

Referring now to the drawings, FIGS. 1-17B illustrate exemplary embodiments of a household appliance, and a work top for a household appliance, having laundry hanging functionality.

As illustrated in FIGS. 1 and 2, a household appliance, such as a front-loading clothes washer 10 or a dryer 12, includes a housing 14 having a door 16 that provides access to a rotating drum 18 in an interior of the appliance housing 14. The housing 14 includes side panels, a front panel having the door 16, and a top panel forming an upper surface of the housing 14.

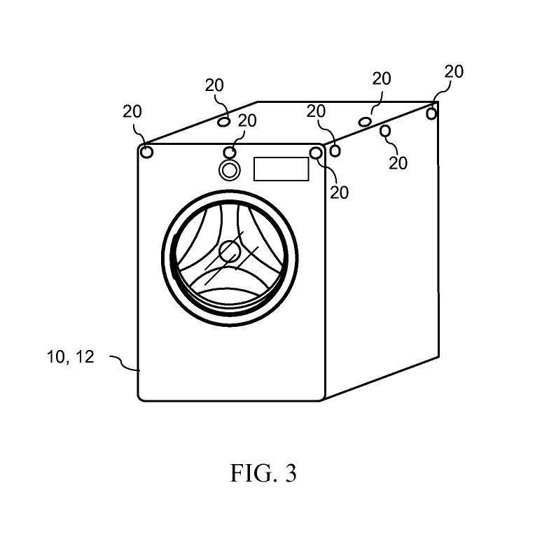

With reference to FIGS. 3-11D, a household appliance, and a work top for a household appliance, having one or more attachment devices for deployable or adjustable laundry hanger rods and rack systems will now be described.

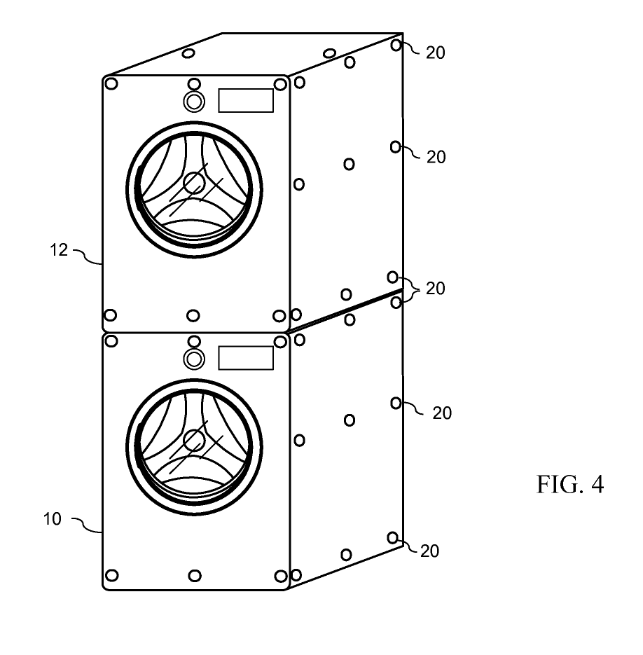

As illustrated in FIGS. 3-5, a household appliance 10, 12 can include one or more attachment devices 20 for receiving means for hanging laundry or clothing, such as extendible or telescopic laundry hanging bars, rods, and laundry rack systems. The attachment devices 20 can be integrally formed with the housing 14 of the laundry appliance 10, 12, as shown in FIGS. 3 and 4.

The attachment devices 20 can be disposed at one or more locations on the housing 14 of the laundry appliance 10, 12. For example, as shown in FIG. 3, a plurality of attachment devices 20 can be integrally formed in one or more of the front panel and the side panels of the housing 14. The attachment devices 20 can be formed adjacent to an upper edge and/or adjacent to an upper corner of the laundry appliance 10, 12. The attachment devices 20 can be formed on an upper surface (i.e., work surface) of the laundry appliance 10, 12, for example, adjacent to an edge or corner of the upper surface.

As shown in FIG. 4, the attachment devices 20 additionally or alternatively can be formed adjacent to a lower edge and/or adjacent to a lower corner of the laundry appliance 10, 12. In this manner, when the laundry appliances 10, 12 are configured in a stackable configuration, the attachment devices 20 formed adjacent to the lower edge or lower corners of the upper (i.e., stacked) laundry appliance (e.g., 12) can be used to support one or more means for hanging laundry or clothing.

The attachment devices 20 additionally or alternatively can be formed at other locations on the side panels or upper surface of the laundry appliance 10, 12. For example, as shown in FIG. 4, the attachment devices 20 can be formed mid-way along the height of the side panels of the appliance, thereby providing greater flexibility and selectively and adjustability for the user. One of ordinary skill in the art will recognize that any number of attachment devices 20 and locations thereof can be provided without departing from the spirit and scope of the invention. For example, a plurality of attachment devices 20 can be disposed at a plurality of heights or levels along the side panels or front panel of the laundry appliance 10, 12.

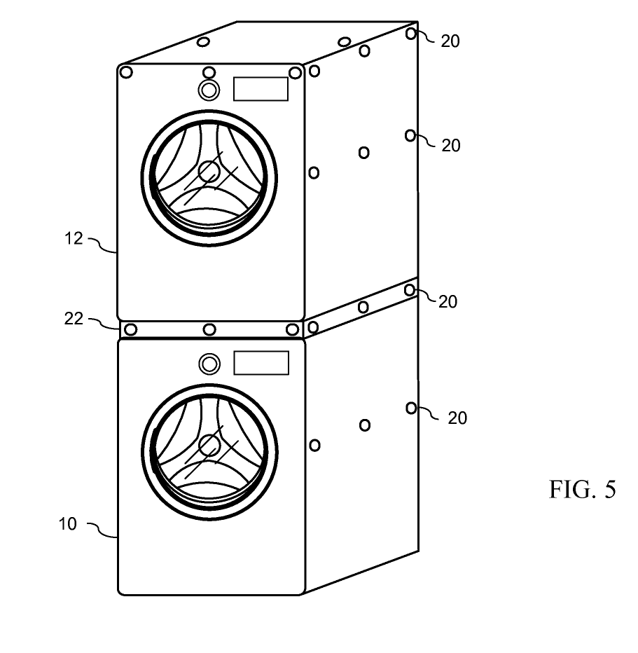

In another embodiment, for example as shown in FIG. 5, a work top 22 can be provided on top of a laundry appliance, such as washer 10. Another laundry appliance, such as a dryer 12, can be stacked on the washer 10 such that the work top 22 is sandwiched between the washer 10 and the dryer 12. The worktop 22 can include one or more attachment devices 20 for receiving means for hanging laundry or clothing, such as extendible or telescopic laundry hanging bars, rods, and laundry rack systems.

An attachment device 20 can include, for example, a structure forming a port or socket for receiving deployable or adjustable laundry hanger rods and/or rack systems. The attachment device 20 can be integrally formed in the housing 14 of the laundry appliance 10, 12. In other embodiments, the attachment device 20 can include, for example, a base having a port or socket for receiving deployable or adjustable laundry hanger rods and rack systems. The base can be coupled to the housing 14 of the laundry appliance 10, 12.

The attachment device 20 can include a flap or cover (e.g., a pivotable or translatable flap or cover) that covers the opening of the attachment device 20 to hide the attachment device 20, or to provide an appearance of a clean and uninterrupted surface of the housing of the laundry appliance 10, 12, during a state of non-use.

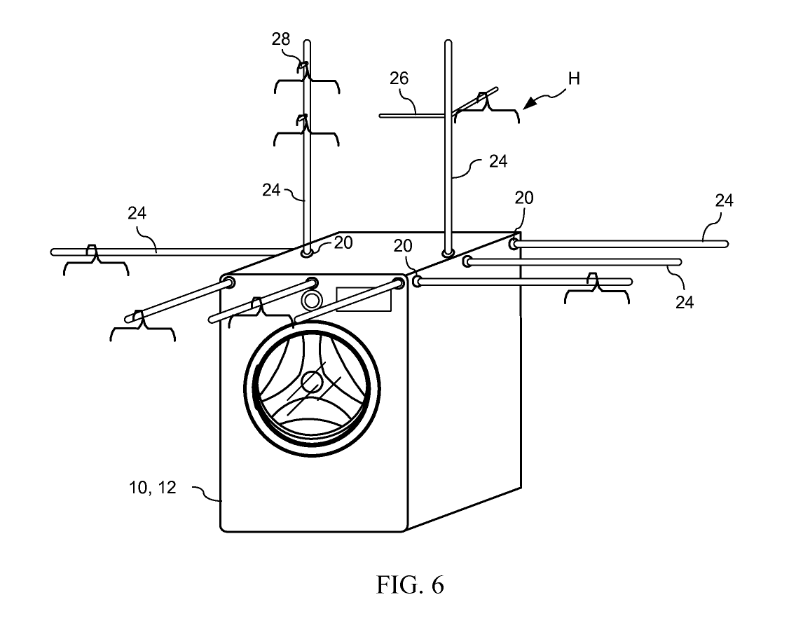

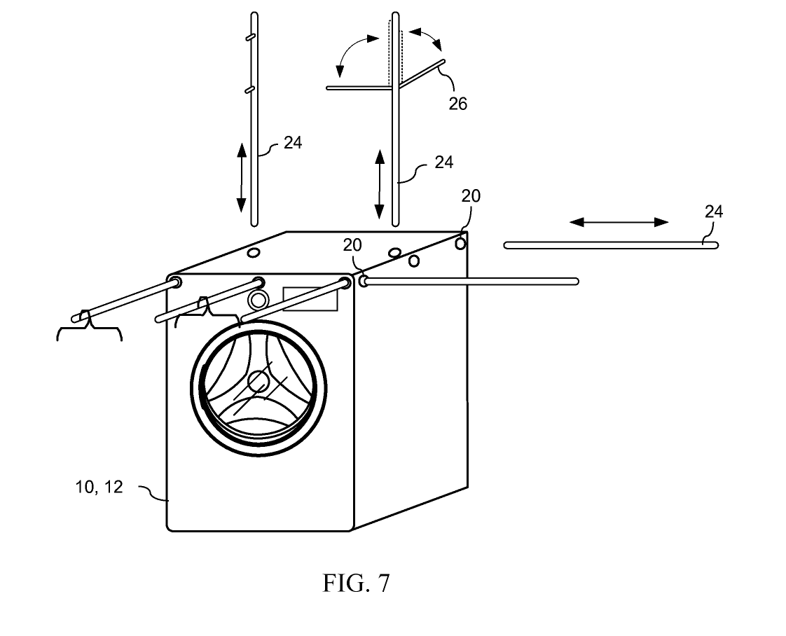

With reference to the exemplary embodiment of FIGS. 6 and 7, the attachment device 20 can be configured to releasably engage and support an end, for example, of a laundry hanging rod 24 or other laundry hanging device.

For example, as shown in FIG. 6, when a user needs to hang laundry that is being removed from the laundry appliance, one or more laundry hanging rods 24 can be coupled to one or more attachments point 20, thereby easily and efficiently providing secure means for hanging laundry from the laundry appliance. The laundry can be hung directly on the rods 24, or the rods 24 can be used to support hangers H for hanging laundry.

As shown in FIG. 7, when a rod 24 is no longer needed to hang laundry, the rod 24 can be released and removed from the attachment device 20 for storage away from the laundry appliance, such as in a linen closet or cabinet, or secured to a rear panel of the laundry appliance out of sight from the user. The laundry hanging rod 24 can be configured to be easily released from within the attachment device 20 such that the rod 24 can be quickly and efficiently removed and stored, or moved from one attachment device 20 to another attachment device 20, for example, without tools.

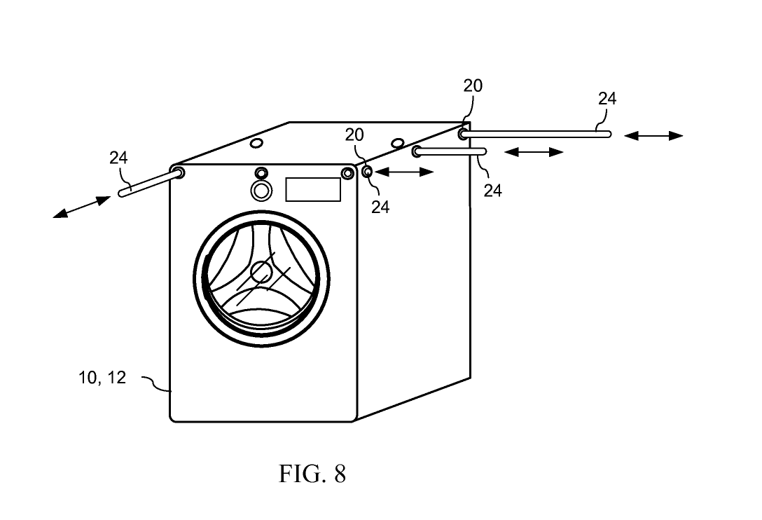

With reference to the exemplary embodiment of FIG. 8, the attachment device 20 can be configured to receive therein all, or a portion, of the length of a laundry hanging rod 24. In this manner, the rod 24 can be selectively stored within a cavity, channel, hollow cylinder, or tube that is concealed within the housing 14 of the laundry appliance when the rod 24 is not in use. The rod 24 can be deployed or extended from the attachment device 20 when the user needs to hang laundry that is being removed from the laundry appliance, thereby easily and efficiently providing secure means for hanging laundry from the laundry appliance. The laundry can be hung directly on the rods 24, or the rods 24 can be used to support hangers H for hanging laundry. When a rod 24 is no longer needed to hang laundry, the rod 24 can be returned or pushed into the attachment device 20 and cavity, channel, hollow cylinder, or tube within the housing of the laundry appliance for storage.

The laundry hanging rod 24 can be configured to be securely engaged with the attachment device 20 such that the rod 24 cannot be removed from the attachment device 20 without tools. Alternatively, the laundry hanging rod 24 can be configured to be easily released from within the attachment device 20 such that the rod 24 can be easily and efficiently removed from one attachment device 20 and relocated to another attachment device 20, for example, without tools.

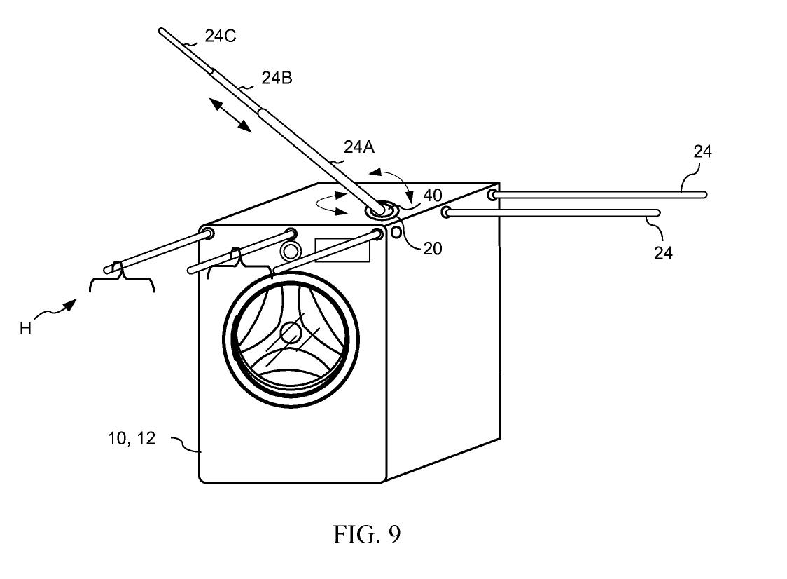

With reference to the exemplary embodiment of FIG. 9, the attachment device 20 can be configured to receive an end of a laundry hanging rod 24 and to facilitate movement of the inserted laundry hanging rod 24. For example, the attachment device 20 can be configured to pivot and/or swivel, such that the laundry hanging rod 24 can be selectively positioned and adjusted by the user in any number of positions (e.g., a fixed number of positions or an infinite number of positions). For example, the attachment device 20 can include a base portion and a coupling portion 40 that is pivotable and/or rotatable about the base portion. The laundry hanging rod 24 can be secured in the coupling portion 40.

As shown in FIG. 9, the laundry hanging rod 24 can be formed from a plurality of telescopic portions 24, 24B, 24C that can be extended or collapsed to change the length of the laundry hanging rod 24, thereby providing greater flexibility and adjustability for the user. The laundry hanging rod 24 is illustrated with three telescopic portions. However, one of ordinary skill in the art will recognize that any number of telescopic portions can be provided without departing from the spirit and scope of the invention.

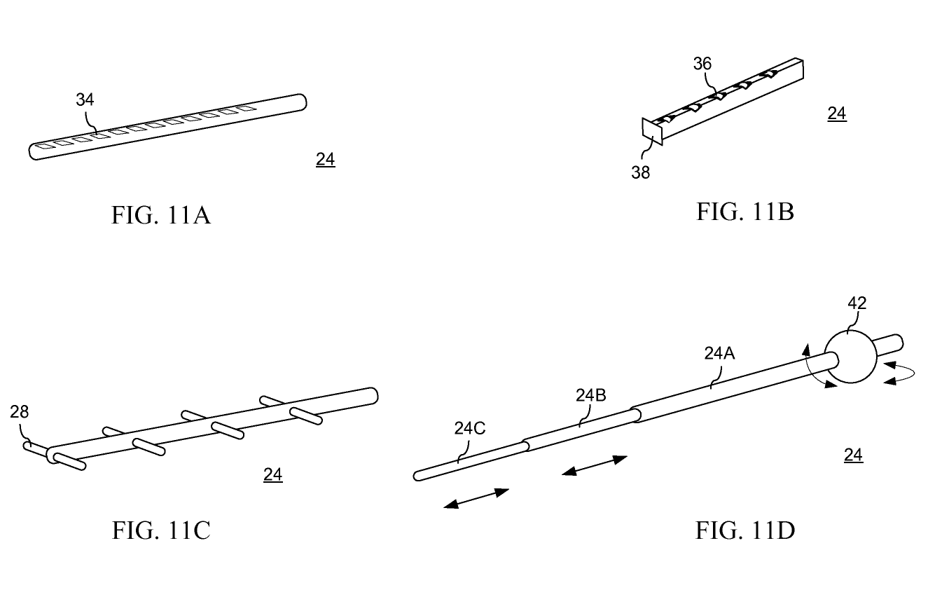

Alternatively, an end of the laundry hanging rod 24 can include a pivot and/or swivel joint 42 that engages a fixed attachment device 20 on the laundry appliance, as shown in FIG. 11D. In this embodiment, a first end of the rod 24 or the pivot and/or swivel joint 42 can be secured to the attachment device 20. The pivot and/or swivel joint 42 can permit a second end of the rod 24 to be moved (e.g., pivoted and/or swiveled) with respect to the pivot and/or swivel joint 42.

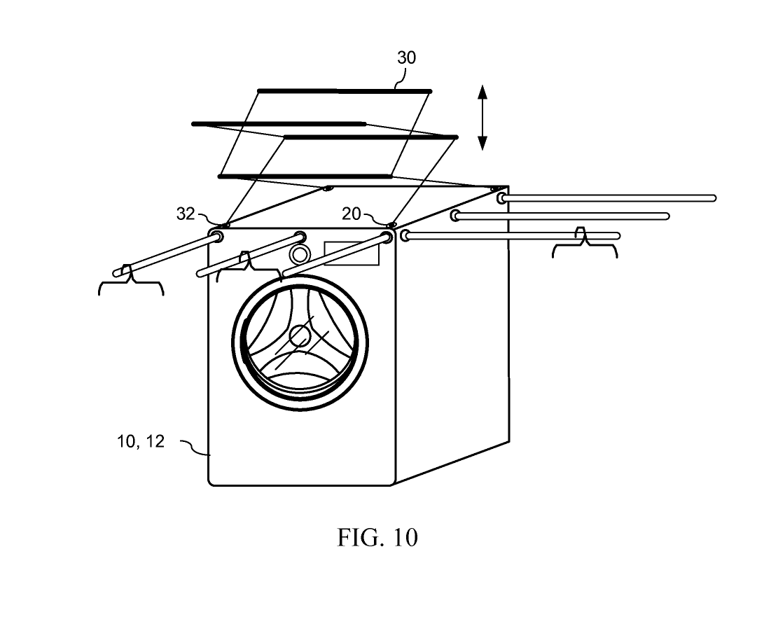

With reference to FIG. 10, another embodiment can include a collapsible drying rack 30 that engages one or more attachment devices 20 on the housing 14 (e.g., on an upper surface of the housing 14) of the laundry appliance. The rack 30 can include feet or supports 32 that engage one or more attachment devices 20. The attachment devices 20 can be disposed adjacent to the corners of the upper surface of the laundry device to receive the feet or supports 32 of the rack 30. In another embodiment, less than all of the feet or supports 32 of the rack may engage an attachment device 20. The attachment device 20 can be configured as a port, socket, or base for receiving the feet or supports 32 of the rack 30. The attachment device 20 can be configured to releasably or fixedly engage and secure the feet or supports 32 of the rack 30.

The laundry hanging rack 30 can have a fixed orientation, or can be configured to be collapsible onto the upper surface of the laundry appliance. The attachment devices 20 can be configured to enable the feet 32 to move a sufficient amount such that the rack 30 can be collapsed or extended without having to release or remove the feet 32 from the attachment devices 20. Alternatively, the attachment devices 20 can be configured to pivot and/or swivel to enable the rack 30 to be collapsed or extended without being released or removed from the attachment devices 20. The housing 14 of the laundry appliance can include, for example, one or more recesses, grooves, or the like for receiving the portions of the collapsed rack 30 and concealing the rack 30, for example, under one or more cover portions (not shown) when the rack 30 is in an unused state.

As shown for example in FIGS. 6-11D, the laundry hanging rod 24 can have various configurations, sizes, and shapes.

For example, the laundry hanging rod 24 can be a fixed-length rod, as shown for example in FIGS. 6 and 7. In other embodiments, the laundry hanging rod 24 can be formed from a plurality of telescopic portions (e.g., 24, 24B, 24C) that can be extended or collapsed to change the length of the laundry hanging rod 24, as shown in FIGS. 9 and 11D.

One of ordinary skill in the art will recognize that the laundry hanging rods 24 illustrated in the exemplary embodiments of FIGS. 6-9 can be fixed-length rods or telescopic rods. For example, the rods 24 of FIGS. 6 and 7 can be telescopic to provide more compact storage of the rods 24 after the rods 24 are removed from the attachment devices 20. In FIG. 8, the rods 24 can be telescopic such that the size of the cavity, channel, cylinder, or tube within the housing 14 can be reduced or limited, for example, to minimize space within the housing 14 or to avoid interfering with other internal components and systems of the laundry appliance.

With reference again to FIGS. 6 and 7, the laundry hanging rod 24 can include one or more hanger supports 26 and 28, which may be fixed or moveable (e.g., collapsible or pivotable) to provide greater flexibility and adjustability for the user, to minimize storage space, or to provide selective clearance for other hanging laundry, such as larger laundry items. The hanger supports 26 and 28 can be different lengths and shapes, and may also be removable, configurable, or interchangeable to provide greater flexibility and adjustability for the user.

The laundry hanging rod 24 can have a solid surface or a perforated surface, for example, for reducing weight of the rod 24. The rod 24 can include smooth or textured surfaces. As shown in FIGS. 11A and 11B, one or more surfaces or sides of the rod 24 can include one or more openings, such as slots, perforations, etc. 32 in FIG. 11A, or one or more notches or grooves 34 in FIG. 11B for directly hanging laundry thereon or for hanging hangers for supporting laundry. The rod 24 can include an end cap 36 for preventing hanger H from sliding off of the rod 24.

As shown in FIG. 11C, the laundry hanging rod 24 can include one or more hanger supports 28 (or 26 in FIG. 6) on one or more surfaces of the rod 24. The hanger supports 26 and 28 can be bars, rods, hooks, etc. extending or projecting from the laundry hanging rod 24. The hanger supports 26 and 28 may be fixed or moveable (e.g., collapsible or pivotable) to provide greater flexibility and adjustability for the user, to minimize storage space, or to provide selective clearance for other hanging laundry, such as larger laundry items. As shown in FIG. 11D, the laundry hanging rod 24 can include a pivot and/or swivel joint 42 that engages a fixed attachment device 20 on the laundry appliance.

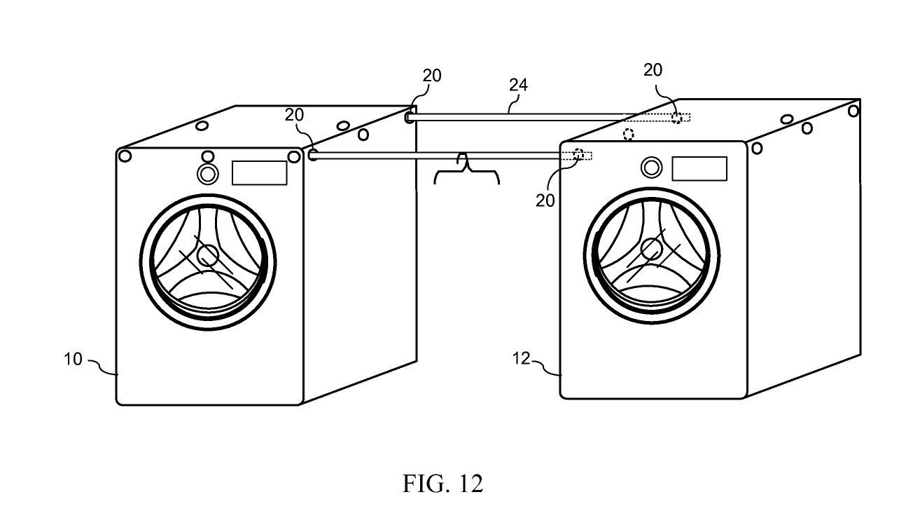

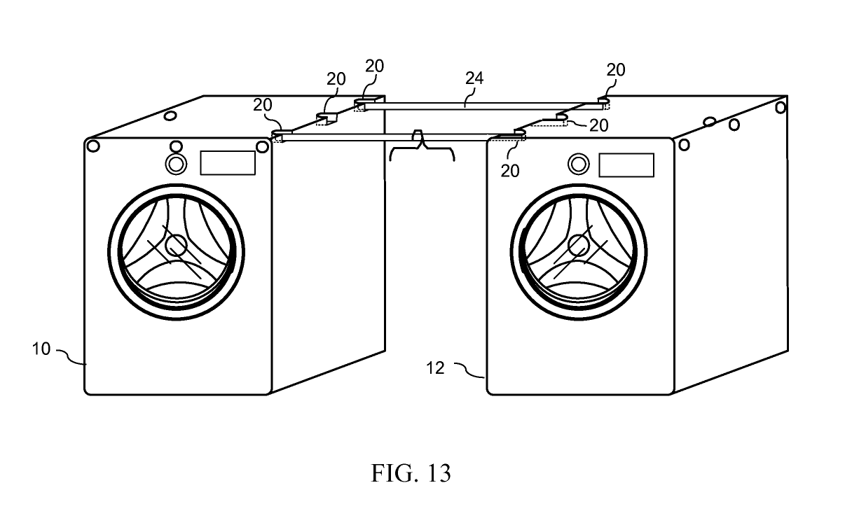

As illustrated in FIGS. 12 and 13, another exemplary embodiment of a laundry system can include a plurality of household appliances 10, 12, each having one or more attachment devices 20 for receiving means for hanging laundry or clothing, such as one or more extendible or telescopic laundry hanging bars, rods, and/or laundry rack systems 24, 30. A laundry system including a pair of household appliances 10, 12 can be arranged in a side-by-side configuration such that one or more attachment devices 20 on each of the household appliances 10, 12 are opposed to each other.

The attachment devices 20 can be integrally formed with the housing 14 of the laundry appliances 10, 12 and disposed at one or more locations on the housing 14 of each laundry appliance 10, 12. For example, as shown in FIG. 12, a plurality of attachment devices 20 can be integrally formed in one or more of the front panel and the side panels of each housing 14. As shown in FIG. 13, the attachment devices 20 can be formed on an upper surface (i.e., work surface) of each laundry appliance 10, 12, for example, at an edge or corner of the upper surface, for example, such that the attachment device 20 has an opening facing away from the upper surface (i.e., work surface) and/or the surface of the side panel (or front panel). For example, the attachment device 20 can include a notch, channel, or cutout formed on an edge of the appliance 10, 12, such as a U-shaped cutout, that can receive an end of the rod 24 and support the end of the rod 24 in a substantially horizontal position, for example, between the pair of side-by-side laundry appliances 10, 12.

As shown in FIGS. 12 and 13, the laundry system can include one or more extendible or telescopic laundry hanging bars, rods, and/or laundry rack systems 24, 30 that are coupled to one or more opposing attachment devices 20 of each of the side-by-side laundry appliances 10, 12. For example, a laundry hanging rod 24 can have a first end coupled to a first attachment device 20 of the washer 10 and a second end coupled to a second attachment device 20 of the dryer 12. In this manner, the load or force exerted on the rod 24 and/or the laundry appliances 10, 12 can be distributed between the pair of appliances 10, 12. Additionally, since both ends of the rod 24 are supported, the amount of stress on the rod 24 can be reduced or distributed over a larger area of the rod 24.

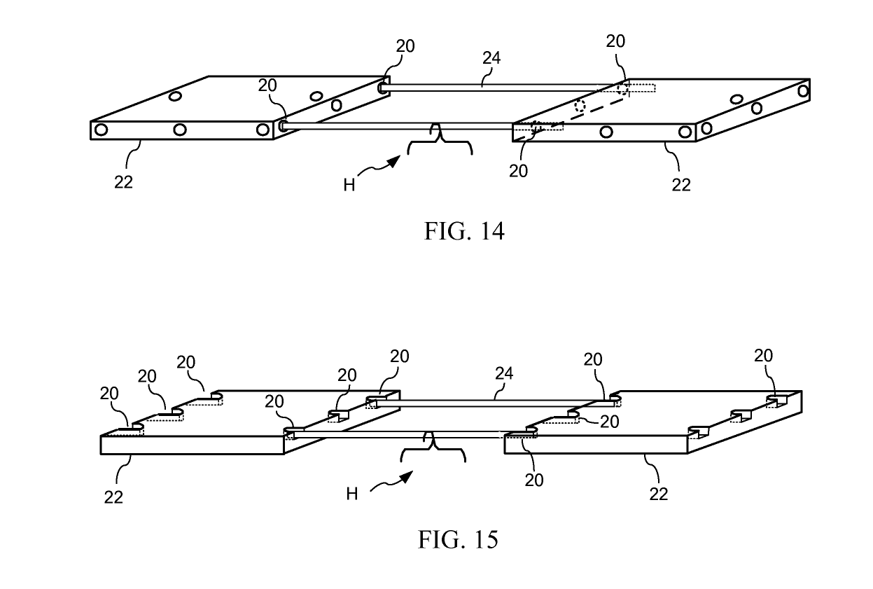

In another embodiment, for example as shown in FIGS. 14 and 15, a laundry system can include a pair of work tops 22 provided for use on top of a pair of laundry appliances 10, 12 arranged in a side-by-side configuration such that one or more attachment devices 20 on a first work top 22 is opposed to an attachment device 20 on a second work top 22.

The attachment devices 20 can be integrally formed with the work tops 22 and disposed at one or more locations on the work tops 22. For example, as shown in FIG. 14, a plurality of attachment devices 20 can be integrally formed in one or more of the front panel and the side panels of each work top 22. As shown in FIG. 15, the attachment devices 20 can be formed on an upper surface (i.e., work surface) of each work top 22, for example, at an edge or corner of the upper surface, for example, such that the attachment device 20 has an opening facing away from the upper surface (i.e., work surface) and/or the surface of the side panel of each work top 22. For example, the attachment device 20 can include a notch, channel, or cutout formed on an edge of the appliance, such as a U-shaped cutout, that can receive an end of the rod 24 and support the end of the rod 24 in a substantially horizontal position, for example, between the pair of side-by-side work tops 22.

As shown in FIGS. 14 and 15, the laundry system can include one or more extendible or telescopic laundry hanging bars, rods, and/or laundry rack systems 24, 30 that are coupled to one or more opposing attachment devices 20 of each of the side-by-side work tops 22 of a pair of side-by-side laundry appliances 10, 12. For example, a laundry hanging rod 24 can have a first end coupled to a first attachment device 20 of a first work top 22 and a second end coupled to a second attachment device 20 of a second work top 22. In this manner, the load or force exerted on the rod 24, the first and second work tops 22, and/or the laundry appliances 10, 12 can be distributed between the first and second work tops 22 and/or the pair of appliances 10, 12. Additionally, since both ends of the rod 24 are supported, the amount of stress on the rod 24 can be reduced or distributed over a larger area of the rod 24.

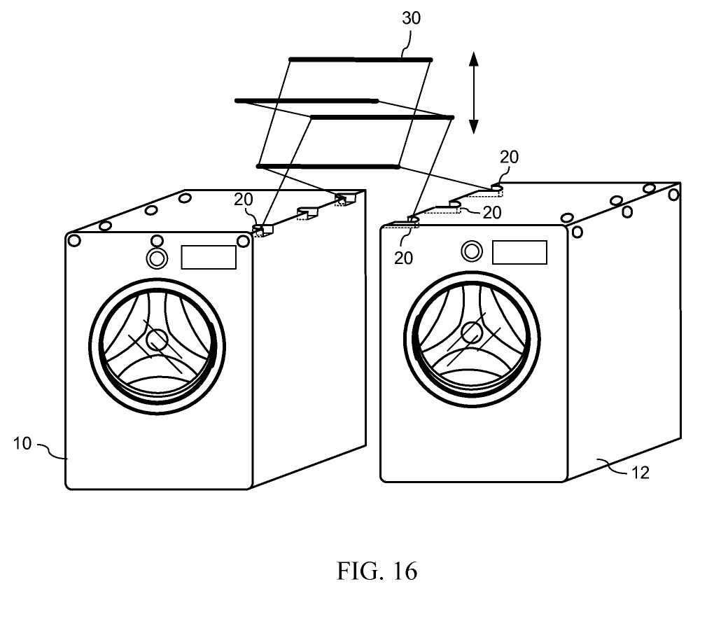

With reference to FIG. 16, in another embodiment, the laundry system can include a laundry hanging rack 30 coupled to one or more opposing attachment devices 20 of each of the side-by-side laundry appliances 10, 12. For example, a laundry hanging rack 30 can have a first pair of supports 32 coupled to attachment devices 20 of the washer 10 and a second pair of supports 32 coupled to attachment devices 20 of the dryer 12. In this manner, the load or force exerted on the laundry hanging rack 30 and/or the laundry appliances 10, 12 can be distributed between the pair of appliances 10, 12. In another embodiment, the laundry system can include a pair of worktops 22 on the washer 10 and dryer 12, wherein each of the worktops 22 includes the attachment devices that are engaged by the supports of the laundry hanging rack 30.

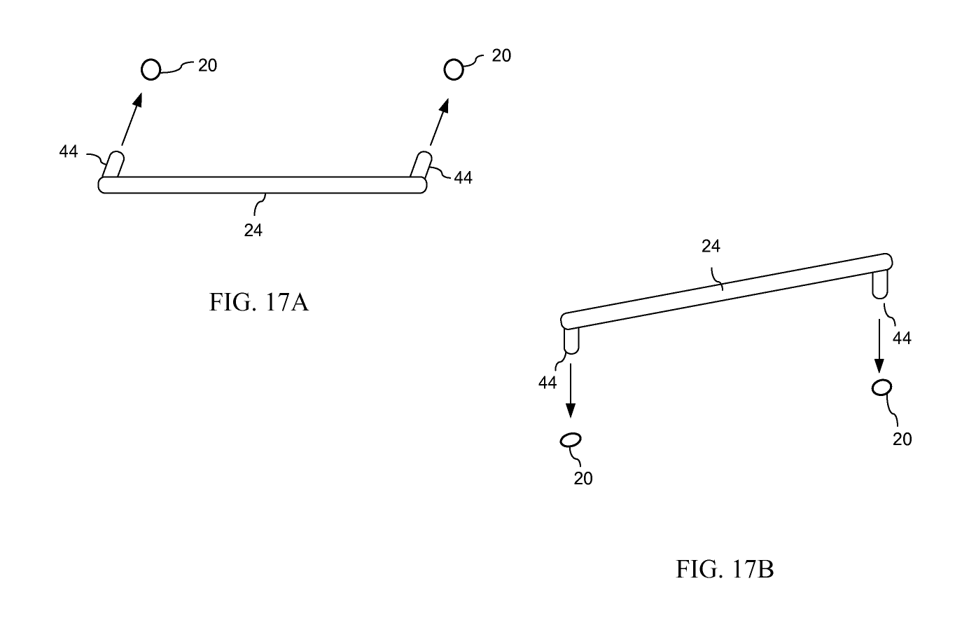

With reference to FIGS. 17A and 17B, another embodiment of a laundry hanging rod 24 can include a projection or extension 44 at each end of the rod 24. Each projection or extension 44 of the rod 24 can be configured to engage an attachment device 20, for example, formed on an upper surface (i.e., work surface), a front panel, or a side panel of a household laundry appliance 10, 12. The laundry hanging rod 24 can be arranged on the front panel or side panel (e.g., wherein each projection or extension 44 lies in a horizontal plane and engages an attachment device 20 formed in the front panel or side panel, as shown in FIG. 17A), or across the upper surface of the household laundry appliance 10, 12 (e.g., wherein each projection or extension 44 lies in a vertical plane and engages an attachment device 20 formed in the upper surface, as shown in FIG. 17B).

In another embodiment, a laundry system can include a laundry hanging rod 24 coupled between a pair of side-by-side household laundry appliances 10, 12. In this embodiment, each projection or extension 44 of the rod 24 can be configured to engage an attachment device 20, for example, formed on an upper surface (i.e., work surface), a front panel, or a side panel of each of the pair of side-by-side household laundry appliances 10, 12. The laundry hanging rod 24 can be arranged, for example, to extend from the front panel of the washer 10 to the front panel of the dryer 12 (e.g., wherein each projection or extension 44 lies in a horizontal plane and engages an attachment device 20 formed in a front panel, as shown in FIG. 17A), or to extend from the upper surface of the washer 10 to the upper surface of the dryer 12 (e.g., wherein each projection or extension 44 lies in a vertical plane and engages an attachment device 20 formed in an upper surface, as shown in FIG. 17B). In another embodiment, the laundry system can include a pair of worktops 22, each disposed on a washer 10 and a dryer 12, respectively, wherein each of the worktops 22 includes the attachment devices 20 that are engaged by the projections or extensions 44 of the laundry hanging rod 24.

An exemplary embodiment is directed to a domestic household laundry appliance (e.g., 10, 12) including a housing 14 having a door 16 for accessing a drum 18 in an interior of the housing 14, attachment means (e.g., 20) on the housing 14, the attachment means (e.g., 20) for securing and supporting laundry hanger means (e.g., 24, 30). The laundry hanger means (e.g., 24, 30) can be releasably secured in the attachment means (e.g., 20).

Another exemplary embodiment is directed to a worktop (e.g., 22) for a domestic household laundry appliance (e.g., 10, 12), the worktop (e.g., 22) having a housing including attachment means (e.g., 20) on the housing, the attachment means (e.g., 20) for securing and supporting laundry hanger means (e.g., 24, 30). The laundry hanger means (e.g., 24, 30) can be releasably secured in the attachment means (e.g., 20).

Another exemplary embodiment is directed to a laundry system including a pair of side-by-side laundry appliances, and/or a pair of worktops (e.g., 22) for a pair of side-by-side household laundry appliances (e.g., 10, 12), the laundry system including attachment means (e.g., 20) for securing and supporting laundry hanger means (e.g., 24, 30) between the pair of side-by-side laundry appliances, and/or the worktops (e.g., 22) of the pair of domestic household laundry appliances (e.g., 10, 12). The laundry hanger means (e.g., 24, 30) can be releasably secured in the attachment means (e.g., 20).

In this manner, the laundry hanging devices may be selectively and adjustably inserted into attachment devices integrally formed with or on the appliance housing or worktop. The laundry hanging devices may be selectively and adjustably extendible and/or collapsible into the attachment devices on the housing of the laundry appliance or worktop, or onto a surface of the housing of the laundry appliance or worktop. The attachment devices may be integrally formed with the appliance housing or worktop housing to be hidden or concealed when not in use, or to be flush with the surface of the housing of the laundry appliance or worktop when not in use, or otherwise unobtrusive to the user. The laundry hanging devices may be selectively and adjustably movable from a stored position to a deployed position.

The present invention has been described herein in terms of several preferred embodiments. However, modifications and additions to these embodiments will become apparent to those of ordinary skill in the art upon a reading of the foregoing description. Like numbers refer to like elements throughout. In the figures, the thickness of certain lines, layers, components, elements or features may be exaggerated for clarity.

What is claimed is:

1. A domestic household laundry appliance comprising:
a housing having a door for accessing an interior of the housing; and
an attachment device on the housing, the attachment device for securing and supporting a laundry hanger device.

2. The domestic household laundry appliance of claim 1, wherein the attachment device includes one of a port and a socket integrally formed with the housing.

3. The domestic household laundry appliance of claim 1, wherein the attachment device includes:
a base coupled to the housing; and
one of a port and a socket integrally formed with the base.

4. The domestic household laundry appliance of claim 1, further comprising:
a worktop on the housing,
wherein the attachment device includes one of a port and a socket integrally formed with a surface of the worktop.

5. The domestic household laundry appliance of claim 1, further comprising:
a worktop on the housing,
wherein the attachment device includes:
a base coupled to a surface of the worktop; and
one of a port and a socket integrally formed with the base.

6. The domestic household laundry appliance of claim 1, wherein the attachment device includes an opening in communication with a cavity within the housing.

7. The domestic household laundry appliance of claim 1, further comprising:
a worktop on the housing,
wherein the attachment device includes an opening in communication with a cavity within the worktop.

8. The domestic household laundry appliance of claim 1, further comprising:
the laundry hanger device,
wherein the laundry hanger device is releasably secured in the attachment device.

9. The domestic household laundry appliance of claim 8, wherein the laundry hanger device includes one of:
a fixed-length laundry hanging rod; and
a variable-length laundry hanging rod.

10. The domestic household laundry appliance of claim 8, wherein the laundry hanger device includes a telescopic laundry hanging rod.

11. The domestic household laundry appliance of claim 8, wherein the laundry hanger device includes a laundry hanging rack.

12. The domestic household laundry appliance of claim 11, wherein the laundry hanging rack includes an extendible and collapsible laundry hanging rack.

13. The domestic household laundry appliance of claim 11, wherein the laundry hanging rack includes a support foot that is releasably secured in the attachment device.

14. The domestic household laundry appliance of claim 6, further comprising:
the laundry hanger device,
wherein the laundry hanger device includes a laundry hanging rod releasably secured in the attachment device, and
wherein the laundry hanging rod is moveable between a stored position in the cavity of the housing and a deployed position in which a portion of the laundry hanging rod extends outward from the attachment device away from the housing.

15. The domestic household laundry appliance of claim 8, wherein the laundry hanging device is movable about the attachment device.

16. The domestic household laundry appliance of claim 15, wherein the laundry hanging device is one of:
pivotable about the attachment device between an angle of 0 degrees and 180 degrees; and
rotatable about the attachment device between an angle of 0 degrees and 360 degrees.

17. The domestic household laundry appliance of claim 8, wherein the laundry hanging device includes one of:
a support for hanging laundry items; and
a deployable support for hanging laundry items.

18. The domestic household laundry appliance of claim 8, wherein the laundry hanging device includes one of:
an opening; and
a notch for securing a laundry hanger.

19. The domestic household laundry appliance of claim 8, wherein the laundry hanging device includes an end cap for preventing one of laundry items and a laundry hanger from sliding off of the laundry hanging device.

20. The domestic household laundry appliance of claim 1, wherein the attachment device is formed on one of:
a side panel of the housing; and
a front panel of the housing.

21. The domestic household laundry appliance of claim 20, wherein the attachment device is formed adjacent to an edge of an upper surface of the housing.

22. The domestic household laundry appliance of claim 20, wherein the attachment device is formed adjacent to an edge of a lower surface of the housing.

23. The domestic household laundry appliance of claim 20, wherein the attachment device is formed substantially at a mid-point between an upper edge of the housing and a lower edge of the housing.

24. The domestic household laundry appliance of claim 1, wherein the attachment device is formed on a top panel of the housing.

25. The domestic household laundry appliance of claim 24, wherein the attachment device is formed adjacent to an edge of one of:
a side panel of the housing; and
a front panel of the housing.

26. The domestic household laundry appliance of claim 1, further comprising:
a plurality of attachment devices formed on one of:
a side panel of the housing;
a front panel of the housing; and
a top panel of the housing.

27. The domestic household laundry appliance of claim 1, wherein the attachment device includes a cutout formed in an edge of the housing.

28. The domestic household laundry appliance of claim 1, further comprising:
a worktop on the housing,
wherein the attachment device is formed on one of:
a side panel of the worktop;
a front panel of the worktop; and
a top panel of the worktop.

29. The domestic household laundry appliance of claim 1, further comprising:
a worktop on the housing,
wherein the attachment device includes a cutout formed in an edge of the worktop.

30. The domestic household laundry appliance of claim 1, wherein the attachment device includes one of:
a moveable cap; and
a moveable cover.

31. The domestic household laundry appliance of claim 8, wherein the attachment device includes:
a base portion; and
a coupling portion that is one of:
pivotable about the base portion; and
rotatable about the base portion,
wherein the laundry hanging device is secured in the coupling portion.

32. The domestic household laundry appliance of claim 1, wherein the domestic household laundry appliance is a dryer.

33. The domestic household laundry appliance of claim 1, wherein the domestic household laundry appliance is a washer.

34. A domestic household laundry appliance comprising:
a housing having a door for accessing an interior of the housing; and
attachment means on one of:
the housing; and
a worktop on the housing,
the attachment means for securing and supporting laundry hanger means.

35. The domestic household laundry appliance of claim 34, further comprising the laundry hanger means releasably secured in the attachment means.

36. A worktop for a domestic household laundry appliance, the worktop comprising:
a housing; and
attachment means on the housing, the attachment means for securing and supporting laundry hanger means.

37. A domestic household laundry system comprising:
a first household laundry appliance including a first housing having a door for accessing an interior of the first housing;
a second household laundry appliance including a second housing having a door for accessing an interior of the second housing;
a first attachment device on one of:
the first housing; and
a first worktop on the first housing; and
a first laundry hanger device secured and supported by the first attachment device.

38. The domestic household laundry system of claim 37, further comprising:
a second attachment device on one of:
the second housing; and
a second worktop on the second housing.

39. The domestic household laundry system of claim 38, further comprising:
a second laundry hanger device secured and supported by the second attachment device.

40. The domestic household laundry system of claim 38, wherein a first end of the first laundry hanger device is secured and supported by the first attachment device and a second end of the first laundry hanger device is secured and supported by the second attachment device.

41. The domestic household laundry system of claim 40, wherein the first household laundry appliance is configured in a side-by-side arrangement with the second household laundry appliance,
wherein the first attachment device is on a side panel of the one of the first housing and the first worktop,
wherein the second attachment device is on a side panel of the one of the second housing and the second worktop, and
wherein the first attachment device is opposed to the second attachment device.

42. The domestic household laundry system of claim 40, wherein the first household laundry appliance is configured in a side-by-side arrangement with the second household laundry appliance,
wherein the first attachment device is on a front panel of the one of the first housing and the first worktop, and
wherein the second attachment device is on a front panel of the one of the second housing and the second worktop.

43. The domestic household laundry system of claim 40, wherein the first household laundry appliance is configured in a side-by-side arrangement with the second household laundry appliance,
wherein the first attachment device is on a top panel of the one of the first housing and the first worktop, and
wherein the second attachment device is on a top panel of the one of the second housing and the second worktop.

44. The domestic household laundry system of claim 40, wherein the first household laundry appliance is configured in a side-by-side arrangement with the second household laundry appliance,
wherein the first attachment device includes a cutout formed in an edge of the one of the first housing and the first worktop,
wherein the second attachment device includes a cutout formed in an edge of the one of the second housing and the second worktop, and
wherein the first end of the first laundry hanger device is secured and supported in the cutout of the first attachment device and the second end of the first laundry hanger device is secured and supported in the cutout of the second attachment device.
